(19) United States
(12) Patent Application Publication
(10) Pub. No.: US 2021/0080005 A1
(43) Pub. Date: Mar. 18, 2021

(54) METHOD FOR MOUNTING A SLEEVE ON A STEERING GEAR

(71) Applicants: thyssenkrupp Presta AG, Eschen (LI); thyssenkrupp AG, Essen (DE)

(72) Inventors: Andreas MÜNSTER, Weissensberg (DE); Sebastian SCHÄDLER, Triesenberg (LI)

(73) Assignees: thyssenkrupp Presta AG, Eschen (LI); thyssenkrupp AG, Essen (DE)

(21) Appl. No.: 16/970,481

(22) PCT Filed: Feb. 28, 2019
(86) PCT No.: PCT/EP2019/054925

§ 371 Date: Aug. 17, 2020

(30) Foreign Application Priority Data
Mar. 7, 2018 (DE) 10 2018 203 412.5

(51) Int. Cl. F16J 3/04; B62D 7/00; B23P 19/04

(52) U.S. Cl. CPC F16J 3/042; B23P 19/047; B62D 7/00

(57) ABSTRACT

A method of assembling a flexible sleeve on a steering gear, wherein the steering gear has a receptacle pin which protrudes axially in the direction of a longitudinal axis and from which a tie rod protrudes in a manner so as to be articulated relative to the longitudinal axis, and the sleeve has a flexible hose-shaped bellows which toward the gear has an annular connecting flange that is configured so as to be coaxial with a flange axis and toward the tie rod has an annular seal.

### PRIOR ART

The invention relates to a method for assembling a flexible sleeve on a steering gear, wherein the steering gear has a receptacle pin which protrudes axially in the direction of a longitudinal axis and from which a tie rod protrudes in a manner so as to be articulated relative to the longitudinal axis, and the sleeve comprises a flexible hose-shaped bellows which toward the gear has an annular connecting flange that is configured so as to be coaxial with a flange axis and toward the tie rod has an annular seal,

comprising the following steps:
moving the connecting flange in order to introduce the tie rod,
offering up the connecting flange to the receptacle pin, and
plug-fitting the connecting flange on the receptacle pin.

The steering gear of a motor vehicle has a gear element which can be moved in a linear manner, for example a rack, a threaded spindle, an electromechanical or hydraulic actuator, or combinations thereof, said gear element hereunder being synonymously referred to as push rod, rack, or threaded spindle. Depending on a steering command which is introduced into the steering wheel, the push rod in the direction of the longitudinal axis thereof is moved relative to the steering gear, which is fixedly connected to the body, to the right or the left in relation to the direction of travel of the vehicle.

The push rod exits in each case on the right and the left from a receptacle pin that projects from the gear housing of the steering gear in the direction of the longitudinal axis. In order for the steering movement to be transmitted to the stub axles of the steerable wheels, a tie rod by way of a joint, referred to as the inner joint, is in each case connected to one end of the push rod. The inner joint which is typically configured as a ball joint, by pivoting the tie rod relative to the longitudinal axis of the push rod, the latter being identical to the longitudinal axis of the receptacle pin, enables a compensation of relative movements of the wheels relative to the body and thus relative to the steering gear.

To protect against the ingress of contaminations it is known for a substantially hose-shaped sleeve made from flexible material, typically an elastic rubber sleeve, to be fitted over the tie rod and to be fixed to the receptacle pin. The sleeve by way of a gear-side connecting flange which faces the steering gear is plug-fitted and fixed in a sealing manner on the receptacle pin, and the tie rod is encompassed in a sealing manner by way of a tie-rod-side annular seal at the steering-gear-distal end region. A flexible, hose-shaped bellows which encompasses the inner joint extends between the connecting flange and the annular seal.

For assembling, the sleeve is threaded onto the tie rod, wherein the tie rod is first introduced into the connecting flange, the bellows is then pulled over the inner joint until the tie rod exits through the annular seal, and the connecting flange by way of the opening thereof is plug-fitted and fixed on the receptacle pin.

On account of the sleeve being flexible and inherently not dimensionally stable, and the tie rod potentially being angled in a non-defined manner in the inner joint, various assembling situations which are not clearly defined arise. Therefore, the assembling to date can take place only manually, wherein craftsmanship is required in order for the sleeve to be threaded onto the tie rod without damaging the bellows or the annular seal by the free end of the tie rod, and for subsequently plug-fitting, or press-fitting, respectively, the in most instances rubber-elastic connecting flange in a form-fitting manner on the receptacle pin. In order for the assembling to be facilitated, the use of an assembly aid in the form of a casing which is pushed over the tie rod and which is intended to avoid damage to the sleeve when threading the latter is known from WO 2005/085027 A1. However, this approach requires an additional effort in terms of labor. Moreover, the production effort is high on account of the manual assembling.

An automated production for minimizing the manufacturing effort cannot be implemented using the methods described in the prior art.

In view of the set of issues explained above, it is an object of the present invention to reduce the manual effort and to specify an automatable method for assembling a sleeve.

### PRESENTATION OF THE INVENTION

This object is achieved according to the invention by a method having the features of claim 1. Advantageous refinements are derived from the dependent claims.

The method according to the invention comprises the following steps:
gripping the bellows in the gripper of a robotic manipulator,
moving the gripper in order to introduce the tie rod through the connecting flange,
inclining the gripper in order to incline the flange axis about a predefined inclination angle relative to the longitudinal axis,
moving the gripper in order to offer up the connecting flange to the receptacle pin,
detecting the impact of the connecting flange on the receptacle pin,
moving the gripper in order to carry out tumbling and/or arcuate and/or translatory assembling movements of the connecting flange relative to the longitudinal axis,
moving the gripper in a force-controlled and/or position-controlled manner in the direction of the longitudinal axis, until a predefined terminal position of the connecting flange on the receptacle pin is reached,
releasing the gripper from the sleeve.
According to the invention, the assembling is performed by means of a robotic manipulator which has a gripper which can be positioned along multiple axes in space.

For example, the gripper can be attached to a robotic arm which can be moved along multiple axes, which is known in the prior art, and is designed so as to correspond to the positioning and assembling movements of the gripper provided according to the invention.

The steering gear is first positioned relative to the robotic manipulator, and a sleeve to be assembled is picked up by the gripper such that a straight passage through the connecting flange, the bellows, and the annular seal is free.

The gripper can preferably be designed such that said gripper at least in portions encompasses the sleeve—preferably on the bellows and/or on the connecting flange—in a shape-supporting manner. On account of the gripper being configured so as to be at least partially complementary to the external shape of the sleeve, said sleeve can be encompassed by the gripper and by way of the internal contour of the gripper that here lies against the outside of said sleeve be forced into a defined assembly shape. In this assembly shape, the connecting flange, the bellows, and preferably also the annular seal, can be aligned in a defined manner so as to be coaxial with a common axis, the flange axis of the connecting flange. In other words, the sleeve which per se is flexible is supported in the gripper and stiffened in a dimensionally stable manner such that said sleeve, despite its flexibility, can be precisely positioned and aligned in a manner similar to a rigid component by means of the robotic manipulator. This is advantageous with a view to automated handling of the sleeve during assembling. The sleeve from the flange opening thereof to the beginning of the annular seal has a first spacing. A second spacing is provided from the flange opening to the beginning of the gripper, or of the mutually opposite grippers, respectively, thus closer to the flange opening. The second spacing is preferably smaller than or equal to one third of the first spacing, the second spacing is further preferably smaller than or equal to one quarter of the first spacing, and the second spacing is further preferably larger than one eighth of the first spacing. The receptacle pin furthermore has a diameter. The second spacing is preferably in a range between −20% to +20% of the diameter of the receptacle pin.

The shape-supporting gripping can take place in that the gripper has movable gripping jaws which in a defined gripping state, for example in a closed state, at least in portions encompass the sleeve in a form-fitting manner, for example in that a cavity which surrounds and supports the sleeve in a form-fitting manner is formed between the gripping jaws that bear against one another. It is likewise conceivable for the gripper to additionally or alternatively be configured in a force-controlled manner, wherein the gripping force is adapted such that the flexible sleeve is not deformed in an undefined manner when said sleeve is being gripped.

In the next step, the threading of the sleeve takes place by moving the gripper in order for the tie rod to be introduced through the connecting flange. The connecting flange here, by way of the gear-side flange opening thereof, is positioned in front of the free end of the tie rod and moved toward the latter. On account thereof, the sleeve, starting with the connecting flange, is threaded onto the tie rod, wherein the tie rod plunges into the interior of the sleeve, that is to say into the bellows. The sleeve in the direction of the flange axis is moved further along on the tie rod so that the tie rod and the inner joint plunge into the bellows.

The sleeve is preferably moved further until the tie rod by way of the free end thereof exits toward the outside through the sealing opening of the gear-distal annular ring toward the tie rod. The sleeve in this intermediate state of assembling is completely threaded onto the tie rod.

The sleeve, conjointly with the tie rod received therein, is inclined relative to the longitudinal axis of the receptacle pin by inclining the gripper in order to incline the flange axis about a predefined inclination angle relative to the longitudinal axis. The inclination takes place about an inclination axis which runs transversely through the longitudinal axis, preferably through the inner joint, wherein the tie rod in the inner joint can be angled relative to the push rod—rack or threaded spindle. The connecting flange in this assembled state is at an inclination angle so as to be oblique to the receptacle pin. Preferably, the flange axis can be at an acute angle to the longitudinal axis.

The offering-up of the connecting flange to the receptacle pin by moving the gripper takes place subsequently, or else in combination with the inclining. The gripper is preferably moved along the longitudinal axis toward the receptacle pin, wherein the longitudinal axis, in a manner corresponding to the inclination, runs obliquely through the flange opening of the connecting flange.

The offering-up is continued until the impact of the connecting flange on the receptacle pin is detected. On account of the inclination, the connecting flange by way of a circumferential portion which on the gear side projects obliquely in relation to the longitudinal axis comes into mechanical contact with the assembly plane on the axial end side of the receptacle pin.

The mechanical impact can be detected in that the gripper is moved in a force-controlled manner by the robotic manipulator. A force, the counterforce, which acts counter to the direction of movement on the gripper here is measured by means of force sensors on the gripper or on the robotic manipulator during the movement, wherein a steep increase of force signals the impact on an obstacle, presently the contact between the sleeve held in the gripper and the gear housing of the steering gear.

The movement of the gripper can take place in a force-controlled manner, as described, and additionally in a position-controlled manner. On account thereof, a plausibility check can take place, for example as to whether the steering gear is correctly positioned for assembling and whether the gripper is located within a permissible assembling range.

The defined inclination of the sleeve and alignment in front of the receptacle pin by the gripping according to the invention of the sleeve in the gripper can in particular be implemented in that the sleeve here is encompassed in a shape-supporting manner, as described above.

By moving the gripper in order to carry out tumbling and/or translatory and/or arcuate assembling movements, the connecting flange is moved relative to the receptacle pin in a manner transverse and/or oblique in relation to the longitudinal axis. In the tumbling movement the inclined flange axis relative to the longitudinal axis orbits on an orbit face which at least in portions has the shape of a conical envelope, wherein the plane defined by the longitudinal axis and the flange axis rotates about the longitudinal axis, while no rotation of the sleeve about the flange axis takes place, so that different circumferential regions of the connecting flange are in each case in orbital contact with the receptacle pin. The tumbling movement can be superimposed with a translatory or arcuate assembling movement of the flange axis that is transverse to the longitudinal axis. For example, the connecting flange can carry out a motion path along a Lissajous curve, said motion path being established by superimposing sinusoidal movements and transversely to the longitudinal axis efficiently passing through a large plurality of relative positions between the connecting flange and the receptacle pin.

It is possible for the aforementioned tumbling movements and/or arcuate movements and/or translatory movements of the connecting flange to set in after the detection of the impact, or else to be carried out already during the offering-up prior to making contact, before the impact takes place.

Force-controlled and/or position-controlled pressing of the gripper in the direction of the longitudinal axis against the receptacle pin, in order to plug-fit the connecting flange on the receptacle pin, until a predefined terminal position of the connecting flange on the receptacle pin is reached takes place according to the invention during the aforementioned assembling movement. The connecting flange while going through the assembling movement assumes a multiplicity of different relative positions in relation to the receptacle pin and here is simultaneously pressed against the receptacle pin. As soon as a relative position which is suitable for plug-fitting is passed here, the contact pressure force exerted ensures that the flange opening of the connecting flange at the end side is forced onto the receptacle pin, in other words the receptacle pin enters the flange opening.

The forcing of the connecting flange onto the receptacle pin can be detected by way of a brief reduction of the counter force which acts on the gripper and acts counter to the contact pressure force exerted and which for force control is measured by the gripper or the robotic manipulator. The assembling movement can then continue to be carried out to the full extent or a partial extent, for example as a pure tumbling movement about the longitudinal axis, or else be completely switched off once the connecting flange has been aligned so as to be coaxial with the longitudinal axis.

Proceeding from the position when forcing, the connecting flange in the direction of the longitudinal axis can be plug-fitted further on the receptacle pin, for example be moved in a position-controlled manner by a predefined distance in the direction of the longitudinal axis, such that an inner seat configured in the flange opening in the fixing position can be positioned on an outer seat configured on the receptacle pin in the required terminal position.

The releasing of the gripper from the sleeve takes place upon reaching the predefined terminal position. In order for the sleeve to be released, gripping jaws of the gripper are diverged, for example, so that the gripper can be removed from the completely assembled sleeve.

In practice, the sleeve can be composed of an elastic material such as rubber or the like, as is known per se. The flange opening of the assembly flange can be elastically widened for assembling on the receptacle pin, this in particular being able to be achieved by the deformations on account of churning and compressing which encircle the connecting flange and are generated during the pressing on account of the tumbling component of the assembling movement. The connecting flange is pushed onto the receptacle pin while being continuously deformed in an encircling manner, on account of which local force peaks in the material of the assembly flange and damage to the sleeve during assembling are largely avoided. The connecting flange in the assembled state sits on the receptacle pin so as to be radially braced in a uniform elastic manner.

A refinement of the method provides that, in order to thread the tie rod into the annular seal, a searching movement transverse to the direction of introduction is carried out upon detecting an impact between the tie rod and the annular seal when introducing the tie rod. When moving the gripper in order to offer up the connecting flange to the receptacle pin, it must be ensured that the sleeve is completely threaded on the tie rod, thus passes through the annular seal to the outside. On account of the relative angular position of the tie rod in the inner joint not being defined during the assembling, the tie rod may be slightly misaligned relative to the through opening of the annular seal such that there is the risk of the free end of the tie rod impacting the bellows or the annular seal and catching thereon from the inside when the sleeve is being pulled on, and of the tie rod not passing through the annular seal, or of damage to the bellows or the annular seal. On account of an impact of the tie rod within the sleeve being detected—preferably by monitoring the force acting on the gripper when introducing the tie rod—a searching movement can be initiated according to the invention, in which searching movement the gripper, preferably in an oscillating movement, repositions the sleeve including the annular seal transversely to the flange axis. The tie rod can exit toward the outside as soon as congruence between the open opening cross section and the cross section of the tie rod is established in the course of the searching movement, and the sleeve is completely threaded on said tie rod. The searching movement can comprise linear, arcuate or orbiting movement components of the annular seal that are transverse to the flange axis.

As an alternative to switching on the searching movement when an impact of the tie rod with the annular seal is detected, it is conceivable and possible for the oscillating searching movement to already be switched on and carried out beforehand, even before the impact of the tie rod on the annular seal takes place. The offering-up movement can in this instance take place simultaneously with the searching movement.

The detection of the impact of the connecting flange on the receptacle pin and of the impact of the annular seal on the receptacle pin can preferably take place by way of a force sensor for the force-controlled movement of the gripper. The impact is detected by way of a brief steep increase in the counter force, while the entry of the receptacle pin or the passing through of the tie rod is detected by a drop in the counter force. The case of the axle journal or the tie rod canting and being unable to be threaded can be identified in that the counter force does not drop. An emergency stop of the robotic manipulator can be initiated in this instance, or the assembling can be repeated.

The connecting flange is preferably configured as a hollow-cylindrical ring, wherein an internal cylindrical casing face forms the inner seat. In a manner corresponding thereto, the receptacle pin externally can likewise be configured so as to be cylindrical, wherein the outer seat is configured on the external casing face of said receptacle pin.

It can furthermore be provided that the connecting flange and the receptacle pin have communicating seat elements which mutually engage in a form-fitting manner. The seat elements can configure a form-fit that is effective in the direction of the longitudinal axis when the connecting flange in the terminal position sits on the receptacle pin. On the receptacle pin the form-fit element on the otherwise cylindrical seat can have an encircling, radially projecting rib having an angular or radiused cross section, for example, which in a form-fitting manner engages in a communicating encircling groove which is configured on the inside of the seat of the connecting flange. In order for a rubber-elastic connecting flange to be assembled according to the invention, said connecting flange is pushed over the receptacle pin and in the transition here is initially radially widened by the rib until said rib snap-fits in the groove. This can be detected by means of the counter force which acts on the gripper and briefly decreases when snap-fitting takes place and steeply increases on account of the form-fitting connection that thereafter is effective in the longitudinal direction.

The annular seal in terms of shape and dimensions can be adapted to the tie rod, said annular seal being attached in a sealing manner to the external face of said tie rod. For example, said annular seal can be configured as a hollow-cylindrical ring, or as an O-ring with a radiused profile. The passage cross section of the through opening is preferably dimensioned such that the annular seal lies in an elastic and sealing manner against the tie rod, wherein a displacement capability along the tie rod may be possible in order to permit compensation movements.

The bellows in the manner of a hose or tube extends between the connecting flange and the annular seal, and is preferably configured so as to be integral to the connecting flange and the annular seal, for example as a molded elastic rubber part. The bellows, in a manner known per se, can have at least one bellows crease, preferably a plurality of bellows creases which are successive in the longitudinal direction, which is/are encircling in the circumferential direction. The gripper, in order to grip in the shape-supporting manner described above, can be configured in a complementary manner and have an inner contour which is capable of engaging in an at least partially form-fitting manner with the bellows creases. Positioning of the sleeve in the gripper so as to be defined longitudinally and transversely in relation to the flange axis can be facilitated on account thereof.

### DESCRIPTION OF THE DRAWINGS

Advantageous embodiments of the invention will be explained in more detail hereunder by means of the drawings, in which specifically:

FIG. 1 shows a motor vehicle steering mechanism in a partial, schematic perspective illustration,

FIG. 2 shows a schematic, partially sectional illustration of the steering gear from FIG. 1 in the region of a sleeve,

FIG. 3 shows a first assembly state when carrying out the method according to the invention,

FIG. 4 shows a second assembly state when carrying out the method according to the invention,

FIG. 5 shows a third assembly state when carrying out the method according to the invention,

FIG. 6 shows a schematic illustration of coordinates of a motion path.

### EMBODIMENTS OF THE INVENTION

Identical parts are always provided with the same reference signs in the various figures and are therefore also normally referred to or mentioned only once in each case.

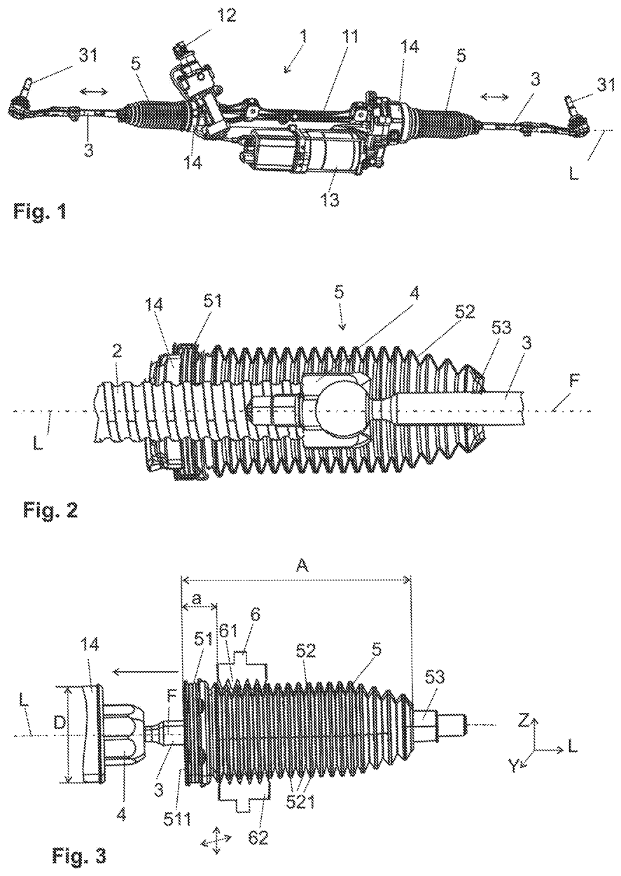

FIG. 1 shows part of a motor vehicle steering mechanism, comprising a steering gear 1 which comprises a gear housing 11 which in the motor vehicle is connected to a body (not illustrated). A steering shaft (not illustrated) which for introducing manual steering commands can be connected to a steering wheel can be connected to an input shaft 12.

In an exemplary manner, a steering mechanism which is supported by auxiliary power and in which an auxiliary power drive 13 for assisting the manual steering torque introduced into the input shaft 12 is connected to the steering gear 1 is illustrated. The auxiliary power drive 13 preferably comprises an electric motor for coupling a motorized auxiliary power into a push rod 2.

A manual rotation of the input shaft 12, and also an introduction of a steering auxiliary torque by way of the auxiliary power drive 13, in the steering gear 1 is converted into a translatory movement of the push rod 2 which in the direction of a longitudinal axis L extends transversely to the direction of travel of the vehicle and to which in each case one tie rod 3 is articulated at each end by way of an inner joint 4 configured as a ball joint, as can be derived from FIG. 2.

The push rod 2, which in FIG. 1 is obscured by the gear housing 11, on both sides—on the right and the left in FIG. 1—is in each case guided out of the gear housing 11 by a receptacle pin 14, as can be seen in FIG. 2.

A rotation of the input shaft 12 and steering assistance by the auxiliary power drive 13 in the steering gear 1 is converted into a translatory movement of the push rod 2 to the right or the left along the longitudinal axis L, said movement by way of the two tie rods 3, as is indicated by double arrows in FIG. 1, being transmitted to the stub axles 31 in order to turn the steered wheels of the vehicle (not illustrated).

The push rod 2 as a gear element can comprise a rack which in a manner known per se meshes with a steering pinion that is attached to the input shaft 12, and/or a threaded spindle—as is illustrated in an exemplary manner in FIG. 2—when the auxiliary power drive 13 has a spindle drive with a spindle nut which can be rotatably driven in a motorized manner and in which the threaded spindle 2 engages.

The auxiliary power drive 13 can be omitted in a purely manual steering mechanism. The input shaft 12 can be omitted in a purely motorized steering mechanism without any direct manual steering intervention, for example in a so-called steer-by-wire steering system without any direct mechanical coupling between the steering wheel and the steering gear 1, and the steering angle is generated exclusively by, preferably electrically, actuating the auxiliary power drive 13.

One sleeve 5 which is preferably configured as a flexible molded elastic rubber part is attached to each of the two receptacle pins 14. The sleeve 5 has a connecting flange 51 having a flange axis F, said connecting flange 51 toward the gear being integrally configured on a bellows 52, an annular seal 53 which is likewise configured so as to be integral to the bellows 52 being attached to the gear-distal end of said bellows 52 toward the tie rod. The bellows 52 preferably has a plurality of encircling bellows creases 521. The connecting flange 51 is configured so as to be annual, having a circular flange opening 511 which is coaxial with the flange axis F.

In the assembly state according to FIG. 2, the connecting flange 52 by way of the flange opening 511 thereof is plug-fitted on the receptacle pin 14. The longitudinal axis L here is congruent with the flange axis F. The sleeve 5, from the flange opening 511 thereof to the beginning of the annular seal 53, has a first spacing A. A second spacing a is provided from the flange opening 511 to the beginning of the gripper 6, or of the mutually opposite grippers, respectively, thus closer toward the flange opening 511. The second spacing a is preferably smaller than or equal to of the first spacing A, the second spacing is further preferably smaller than or equal to of the first spacing A, and the second spacing a is further preferably larger than of the first spacing A. The receptacle pin 14 furthermore has a diameter D. The second spacing a is preferably in a range between −20% to +20% of the diameter D of the receptacle pin 14.

FIG. 3 shows a first assembly state when carrying out the method according to the invention. A gripper 6 between the gripping jaws 61 and 62 thereof here encompasses the bellows 52 in a shape-supporting manner. To this end, the gripping jaws 61 and 62 on the inside are shaped so as to be complementary to the bellows creases 521 so that the sleeve 6 is aligned in a form-fitting manner in the gripper 6 and so as to be spatially defined longitudinally as well as transversely to the flange axis F.

In FIG. 3, the connecting flange 52 is partially threaded onto the tie rod 3, wherein the tie rod 3 through the flange opening 511 plunges into the bellows 52 but does not exit again through the annular seal 53. In order for the sleeve 5 to be completely threaded on the tie rod 3, the gripper 6 is made to move in an oscillating searching movement that is transverse to the flange axis F, thus toward the top and the bottom in the drawing plane, for example, and additionally or alternatively out of and into the drawing plane, as is indicated by the intersecting arrows, in other words in the y direction and/or the z direction which are perpendicular to the direction of the longitudinal axis L.

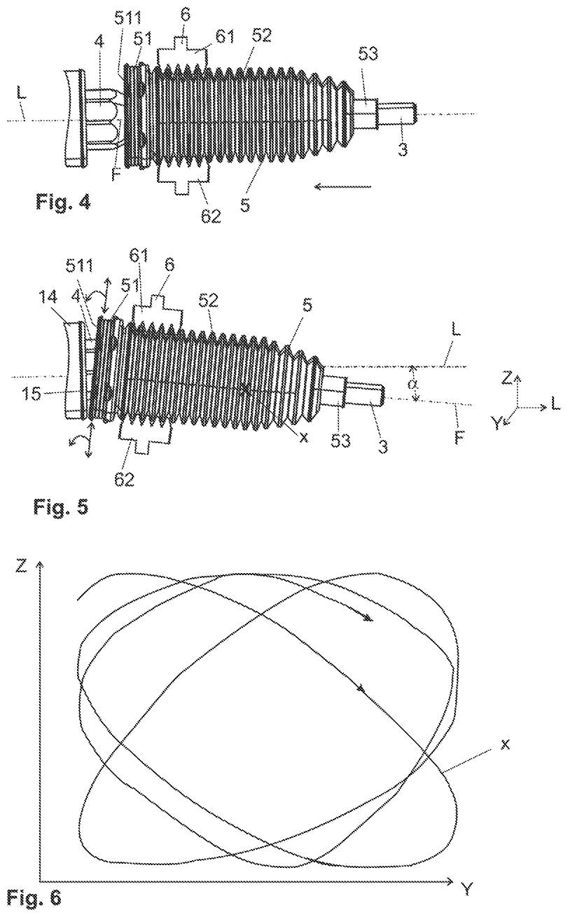

On account of the gripper 6 being moved toward the receptacle pin 14, the annular seal 53 is moved toward the free end of the tie rod 3. When the cross section of the tie rod 3 is congruent with the opening cross section of the annular seal 53, the tie rod 3 passes through the annular seal 53 so that the assembly state shown in FIG. 4, in which the sleeve 5 is completely threaded onto the tie rod 3, is reached. Should the end of the tie rod 3 impact or catch from the inside on the annular seal 53 or the bellows 52, said tie rod 3 is released on account of the oscillating searching movement and will pass through toward the outside—toward the right in FIG. 3—as soon as congruence between the open opening cross section of the annular seal 53 and the cross section of the tie rod 3 is established in the course of the searching movement, and the sleeve 5 is completely threaded on. The searching movement here can comprise linear, arcuate or orbiting movement components of the annular seal 53 that are transverse to the flange axis F.

The gripper 6 from the assembly position of FIG. 4 is inclined such that the flange axis F is inclined about a predefined inclination angle α (alpha) relative to the longitudinal axis L, as is illustrated in FIG. 5. The sleeve 5 here, conjointly with the tie rod 3 received therein, is inclined relative to the longitudinal axis L of the receptacle pin 14. The inclination takes place about an inclination axis which runs transversely through the longitudinal axis L, preferably through the inner joint 4, wherein the tie rod 3 in the inner joint 14 can be angled relative to the tie rod 2—the rack or threaded spindle. In this assembly state, the connecting flange 51 is oblique in relation to the receptacle pin 14 at the inclination angle α (alpha). The flange axis F can preferably be at an acute inclination angle α (alpha) in relation to the longitudinal axis L.

The sleeve 4 from the assembly position of FIG. 4 can first be inclined and then be moved to the receptacle pin 14 by moving the gripper 6 until the connecting flange 51 impacts obliquely on the receptacle pin 14, as is illustrated in FIG. 5. Alternatively, the offering-up can take place first and the inclining can take place thereafter, or else the offering-up and the inclining can take place in a combined movement, until the position shown in FIG. 5 is reached.

The impact can be detected by a force-controlled movement of the gripper 6, wherein it is continually monitored which counter force is acting on the gripper 6. Said counter force steeply increases when the sleeve 5 impacts on the receptacle pin 14.

Subsequently, or already during the offering-up prior to the impact, the sleeve 5 by the gripper 6 is brought into a tumbling and/or translatory and/or arcuate assembling movement about the longitudinal axis L. A point X on the flange axis F, which as illustrated in FIG. 5 has a radial spacing in relation to the longitudinal axis L, for example in an y-z plane which is perpendicular to the longitudinal axis L, here can perform a motion path which is similar to a Lissajous curve, as is shown in a schematic view in a plane transverse to the longitudinal axis L in FIG. 6.

During the aforementioned assembling movement, force-controlled and/or position-controlled pressing of the gripper 6 in the direction of the longitudinal axis L against the receptacle pin 14, in order to plug-fit the connecting flange 51 on the receptacle pin 51, takes place according to the invention until the terminal position of the connecting flange 51 on the receptacle pin 14 shown in FIG. 2 is reached. The connecting flange 51 while going through the assembling movement assumes a multiplicity of different relative positions in relation to the receptacle pin 14 and here is simultaneously pressed against the receptacle pin 14. As soon as a relative position which is suitable for plug-fitting is passed here, the contact pressure force exerted ensures that the flange opening 511 of the connecting flange 51 at the end side is forced onto the receptacle pin 14, in other words the receptacle pin 14 enters the flange opening 511.

The forcing of the connecting flange 51 onto the receptacle pin 14 can be detected by way of a brief reduction of the counter force which acts on the gripper 6 and acts counter to the contact pressure force exerted and which for force control is measured by the gripper 6 or the robotic manipulator. The assembling movement can then continue to be carried out to the full extent or a partial extent, for example as a pure tumbling movement about the longitudinal axis L, or else be completely switched off once the connecting flange 51 has been aligned so as to be coaxial with the longitudinal axis L.

Proceeding from the position when forcing, the connecting flange 51 in the direction of the longitudinal axis L can be plug-fitted further on the receptacle pin 14, for example in a position-controlled manner by a predefined distance in the direction of the longitudinal axis L, such that an inner seat configured in the flange opening 511 in the fixing position can be positioned on an outer seat configured on the receptacle pin 14 in the required terminal position.

In order for a form-fit which is effective in the direction of the longitudinal axis L to be formed in the terminal position, a form-fit element 15 which encircles the cylindrical seat of the receptacle pin 14 and which in the example is configured as a radially projecting rib can latch in a communicating, encircling groove on the inside of the connecting flange 51.

The releasing of the gripper 6 from the sleeve 5 takes place upon reaching the predefined terminal position. In order for the sleeve 5 to be released, gripping jaws 61 and 62 of the gripper 6 are diverged, for example, so that the gripper 6 can be removed from the completely assembled sleeve 5.

### LIST OF REFERENCE SIGNS

1 Steering gear
11 Gear housing
12 Input shaft
13 Auxiliary power drive
14 Receptacle pin
15 Form-fit element
2 Push rod
3 Tie rod
31 Stub axle
4 Inner joint
5 Sleeve
51 Connecting flange
511 Flange opening
52 Bellows
521 Bellows crease
53 Annular seal
6 Gripper
61,62 Gripping jaws
F Flange axis
L Longitudinal axis
A First spacing
a Second spacing
D Diameter of the receptacle pin 14

1.-7. (canceled)

8. A method for assembling a flexible sleeve on a steering gear, wherein the steering gear has a receptacle pin that protrudes axially in the direction of a longitudinal axis and from which a tie rod protrudes in a manner so as to be articulated relative to the longitudinal axis, and the sleeve comprises a flexible hose-shaped bellows which toward the gear has an annular connecting flange that is configured so as to be coaxial with a flange axis and toward the tie rod has an annular seal, comprising:
moving the connecting flange in order to introduce the tie rod,
offering up the connecting flange to the receptacle pin,
plug-fitting the connecting flange on the receptacle pin,
gripping the bellows in the gripper of a robotic manipulator,
moving the gripper so as to introduce the tie rod through the connecting flange,
inclining the gripper so as to incline the flange axis about a predefined inclination angle relative to the longitudinal axis,
moving the gripper so as to offer up the connecting flange to the receptacle pin,
detecting the impact of the connecting flange on the receptacle pin,
moving the gripper so as to carry out tumbling and/or arcuate and/or translatory assembling movements of the connecting flange relative to the longitudinal axis,
pressing the gripper in a force-controlled and/or position-controlled manner in the direction of the longitudinal axis against the receptacle pin, so as to plug-fit the connecting flange on the receptacle pin, until a predefined terminal position of the connecting flange on the receptacle pin is reached, and
releasing the gripper from the sleeve.

9. The method of claim 8 wherein one or both of the gripper or the robotic manipulator is moved in one or both of a force-controlled or position-controlled manner.

10. The method of claim 8 wherein the gripper, at least in portions, encompasses the sleeve in a shape-supporting manner.

11. The method of claim 8 wherein, so as to thread the tie rod into the annular seal, a searching movement transverse to the direction of introduction is carried out when introducing the tie rod.

12. The method of claim 8 wherein, in order to detect the impact of the connecting flange on the receptacle pin, an increase of force in the force acting on the gripper is detected.

13. The method of claim 8 wherein during the assembling movement the connecting flange is plug-fitted on the receptacle pin as a function of the force acting in the direction of the longitudinal axis on the gripper.

14. The method of claim 8 wherein the connecting flange and the receptacle pin have communicating seat elements which mutually engage in a form-fitting manner.
